(19) United States
(12) Patent Application Publication
(10) Pub. No.: US 2012/0224060 A1
(43) Pub. Date: Sep. 6, 2012

(54) Reducing Driver Distraction Using a Heads-Up Display

(75) Inventors: Mikhail Gurevich, Westport, CT (US); Luis Carrasco, Miami, FL (US); Wesley Griswold, Brighton, MA (US)

(73) Assignee: INTEGRATED NIGHT VISION SYSTEMS INC., Westport, CT (US)

(21) Appl. No.: 13/371,382

(22) Filed: Feb. 10, 2012

Related U.S. Application Data
(60) Provisional application No. 61/441,320, filed on Feb. 10, 2011.

(51) Int. Cl. H04N 7/18

(52) U.S. Cl. 348/148; 348/E07.085

(57) ABSTRACT

Driver distraction is reduced by providing information only when necessary to assist the driver, and in a visually pleasing manner. Obstacles such as other vehicles, pedestrians, and road defects are detected based on analysis of image data from a forward-facing camera system. An internal camera images the driver to determine a line of sight. Navigational information, such as a line with an arrow, is displayed on a windshield so that it appears to overlay and follow the road along the line of sight. Brightness of the information may be adjusted to correct for lighting conditions, so that the overlay will appear brighter during daylight hours and dimmer during the night. A full augmented reality is modeled and navigational hints are provided accordingly, so that the navigational information indicates how to avoid obstacles by directing the driver around them. Obstacles also may be visually highlighted.

### CROSS-REFERENCE TO RELATED APPLICATION

This application claims the benefit of U.S. Provisional Patent Application No. 61/441,320, filed Feb. 10, 2011, the contents of which are incorporated by reference in their entirety.

### TECHNICAL FIELD

The invention relates to data processing for visual presentation, including the creation and manipulation of graphic objects, and more particularly to reducing distraction of vehicle drivers using a heads-up display for showing artificial graphic objects on a windshield.

### BACKGROUND ART

Reducing driver distractions due to road obstacles, such as potholes and stray animals, and complexities of modern technology, such as radio and navigation systems, have been a prevalent issue in automotive industry. Even though heads-up display technology (HUD) in of itself has been around for a number of years, previous attempts by leading car manufacturers have failed to solve these two issues for different reasons. In particular, currently available HUD systems, such as those from Mercedes and BMW, only display information on the bottom of the windshield, still requiring the driver to read and mentally process the data, which takes time to understand and apply to situation at hand. This process is the essence of the problem.

### SUMMARY OF EMBODIMENTS OF THE INVENTION

Driver distraction is reduced by providing information only when necessary to assist the driver, and in a visually pleasing manner. Obstacles such as other vehicles, pedestrians, and road defects are detected based on analysis of image data from a forward-facing camera system. An internal camera images the driver to determine a line of sight. Navigational information, such as a line with an arrow, is displayed on a windshield so that it appears to overlay and follow the road along the line of sight. Brightness of the information may be adjusted to correct for lighting conditions, so that the overlay will appear brighter during daylight hours and dimmer during the night. A full augmented reality is modeled and navigational hints are provided accordingly, so that the navigational information indicates how to avoid obstacles by directing the driver around them. Obstacles also may be visually highlighted.

Therefore, there is provided in a first embodiment a method of reducing the distraction of a driver of a motor vehicle, the motor vehicle having a windshield in front of the driver. The method includes four processes. The first process includes receiving an image from a generally front facing camera system mounted on the motor vehicle, the image including data regarding a portion of a road surface generally in front of the motor vehicle and an ambient brightness. The second process includes receiving data pertaining to the position and orientation of the motor vehicle from at least one location sensing device. The third process includes computing a desired route between the position of the motor vehicle and a destination. The fourth process includes displaying, on the windshield, a navigational image that is computed as a function of the desired route, the position and orientation of the motor vehicle, a curvature of the portion of the road surface, and a line of sight of the driver, the navigational image appearing, to the driver, to be superimposed on the road surface in front of the motor vehicle.

The navigational image may have a brightness and a transparency that are calculated as a function of the ambient brightness. Receiving an image may include receiving an active infrared image or receiving a visible light spectrum image. The line of sight of the driver may be determined by analyzing an image of the driver's face. The motor vehicle may be positioned on a road having an intersection, in which case the navigational image may indicate that the driver should turn the motor vehicle at the intersection.

The method may be extended in a further embodiment by displaying on the windshield a shape that appears, to the driver, to surround an object outside the motor vehicle, the object being one of: a point of interest, a road defect, an elevated highway sign, a roadside traffic sign, a pedestrian, animal, or other road debris. The displayed shape may further comprise an iconic label that identifies the object. The method may also include displaying, in a fixed position on the windshield, a textual image that conveys information relating to the highlighted object. When the object is a road defect, the shape may include a column of light that appears to the driver to rise vertically from the road defect. When the object is a pedestrian, animal, or road debris, the shape may include a shaded box that surrounds the detected object. When the object is an elevated highway sign or a roadside traffic sign, the shape may include a shaded box that surrounds the sign. In this case, the method may be extended to include displaying the text of the sign in a fixed position on the windshield.

The basic method may be extended to detect defects in a road surface in four processes. The first process includes projecting a light on the road surface in front of the motor vehicle, the light having a transmission pattern. The second process includes imaging a reflection from the road of the shined light, the reflection having a reflection pattern. The third process includes, in a computing processor, determining a difference between the transmission pattern and the reflection pattern, the difference being indicative of a defect in the road surface. The fourth process includes displaying, on the windshield, an image representing the defect, the displayed image being based on a line of sight of the driver so that the image appears, to the driver, to be superimposed on the road surface in front of the motor vehicle. The light may have infrared frequencies.

The basic method may be extended in yet another way to detect a life form on the road surface. This embodiment requires using a histogram of orientated gradients to identify, in the received image, an object having a bodily symmetry of a life form; and displaying, on the windshield, an image representative of the identified life form.

The basic method may be extended in still another way to detect information pertaining to road signs, using four processes. The first process includes determining that the received image includes a depiction of a road sign. The second process includes analyzing the image to determine a shape of the road sign. The third process includes, if a meaning of the road sign cannot be determined from its detected shape, analyzing the image to determine any text present on a face of the road sign. The fourth process includes displaying, on the windshield, an image relating to the road sign based on the line of sight of the driver. This embodiment may itself be extended by displaying, on a fixed position of the windshield, an image comprising the text of the sign.

There is also provided a system for reducing the distraction of a driver of a motor vehicle, the motor vehicle having a windshield in front of the driver, the windshield having a given three-dimensional shape. The system includes an imaging system configured to produce images on the windshield. The overall system also includes a first camera for imaging the interior of the motor vehicle, the first camera being oriented to capture images of the driver, and a second camera for imaging a road in front of the motor vehicle. The system further includes a touch screen for configuring the system, and a location sensing device for obtaining data that indicate the current position and orientation of the motor vehicle. Finally, the system has a computing processor coupled to the imaging system, first camera, second camera, touch screen, and location sensing device. The computing processor is configured to perform at least four functions. The first function is to determine a line of sight of the driver based on images received from the first camera. The second function is to create navigational images based on data received from the second camera, the location sensing device, data received from the touch screen, and the line of sight. The third function is to transform the navigational images according to the given three-dimensional shape of the windshield. The fourth function is to cause the imaging system to display the transformed images on the windshield so that the images appear, to the driver, to be superimposed on the road surface in front of the motor vehicle.

The second camera may be configured to detect an ambient brightness, and the navigational image may have a brightness and a transparency that are calculated as a function of the ambient brightness. The at least one location sensing device may be a global positioning system receiver, an inertial gyroscope, an accelerometer, or a camera. The processor may determine the line of sight by analyzing an image of the driver's face.

In a related embodiment, the imaging system may be further configured to display a shape that appears, to the driver, to surround an object outside the motor vehicle, the object being one of: a point of interest, a road defect, an elevated highway sign, a roadside traffic sign, a pedestrian, animal, or other road debris. The displayed shape further comprises an iconic label that identifies the object. The imaging system may be further configured to display, in a fixed position on the windshield, a textual image that conveys information relating to the highlighted object. When the object is a road defect, the shape may include a column of light that appears to the driver to rise vertically from the road defect. When the object is a pedestrian, animal, or road debris, the shape may be a shaded box that surrounds the detected object. When the object is an elevated highway sign or a roadside traffic sign, the shape may include a shaded box that surrounds the sign. In this case, the imaging system may be further configured to display the text of the sign in a fixed position on the windshield.

The basic system may also include a light having a transmission pattern aimed at the road surface in front of the motor vehicle, wherein the second camera is configured to image a reflection from the road of the light, the reflection having a reflection pattern. In this case, the computer processor may be further configured to both (i) determine a difference between the transmission pattern and the reflection pattern, the difference being indicative of a defect in the road surface, and (ii) cause the imaging system to display, on the windshield, an image representing the defect, the displayed image being based on a line of sight of the driver so that the image appears, to the driver, to be superimposed on the road surface in front of the motor vehicle. The light may be an infrared light.

The computer processor of the basic system may be further configured to use a histogram of orientated gradients to identify, in the received image, an object having a bodily symmetry of a life form, and to cause the imaging system to display, on the windshield, an image representative of the identified life form.

The computer processor of the basic system may be further configured to detect information pertaining to road signs, using four processes. The first process includes determining that the received image includes a depiction of a road sign. The second process includes analyzing the image to determine a shape of the road sign. The third process includes, if a meaning of the road sign cannot be determined from its detected shape, analyzing the image to determine any text present on a face of the road sign. The fourth process includes displaying, on the windshield, an image relating to the road sign based on the line of sight of the driver. This embodiment may itself be extended by displaying, on a fixed position of the windshield, an image comprising the text of the sign.

The basic system may be extended in another embodiment where the first camera is configured to capture video of one of the driver's hands, the video comprising a succession of images, each image consisting of a plurality of pixels, and the computer processor is further configured to detect the motion of the one of the driver's hands by calculating a motion gradient based on differences between the pixels of successive images of the video, and to issue commands to configure the system based on the direction of the detected motion gradient of the one of the driver's hands relative to a coordinate system. According to this embodiment, the system includes a menu function, a zoom function, and a rotate function, and the direction of the detected motion gradient and a current state of the system together indicate whether to issue, to the system, a selection command, a menu navigation command, a zoom command, or a rotate command.

### BRIEF DESCRIPTION OF THE DRAWINGS

The foregoing features of embodiments will be more readily understood by reference to the following detailed description, taken with reference to the accompanying drawings, in which:

FIG. 1 schematically shows a representation of the cross section of a motor vehicle showing various the relevant system components;

FIG. 2 schematically shows a representation of the system components from a driver's point of view;

FIGS. 3A and 3B are representations of the heads-up display showing different navigational information;

FIG. 4 schematically shows a representation of the heads-up display highlighting identified points of interest in a manner that is aligned with the driver's field of view;

FIG. 5 schematically shows a representation of the heads-up display highlighting a recognized defect in the road and showing a warning;

FIG. 6 schematically shows a representation of the heads-up display highlighting recognized road signs and highway information signs, and showing standardized, iconic interpretations of the same and a warning;

FIG. 7 schematically shows a representation of the heads-up display highlighting a recognized person and a recognized animal in the middle of the road, and showing warnings about the same;

FIGS. 8A-8D are diagrams of hand gestures that may be used to control the distraction reduction system user interface;

FIG. 9 is a block diagram schematically showing the relevant hardware system components and the flow of information between them;

FIG. 10 is a block diagram schematically showing the functional components in the processing unit that control the distraction reduction system;

FIG. 11 is a block diagram schematically showing a process for calculating navigation information for display on the heads-up display, for example as shown in FIGS. 3A-3B;

FIG. 12 is a block diagram schematically showing a process for generating an image of a road and its lanes for display on the heads-up display;

FIG. 13 is a block diagram showing a process for detecting lanes in an image;

FIG. 14 is a block diagram showing a process for generating point-of-interest information for display on the heads-up display, for example as shown in FIG. 4;

FIG. 15 is a block diagram showing a process for detecting road defects and generating image information for display on the heads-up display, for example as shown in FIG. 5;

FIG. 16 is a block diagram showing a process for detecting and interpreting various road signage and generating image information for display on the heads-up display, for example as shown in FIG. 6; and

FIG. 17 is a block diagram showing a process for detecting road obstacles and debris, such as life forms, and generating image information for display on the heads-up display, for example as shown in FIG. 7.

### DETAILED DESCRIPTION OF SPECIFIC EMBODIMENTS

As used in this description and the accompanying claims, the following terms shall have the meanings indicated, unless the context otherwise requires:

A “motor vehicle” includes any navigable vehicle that may be operated on a road surface, and includes without limitation cars, buses, motorcycles, off-road vehicles, and trucks.

A “heads-up display” or HUD is a display of semi-transparent and/or partially opaque visual india that presents visual data to a driver of a motor vehicle without requiring the driver to look away from the road.

A “location sensing device” is a device that produces data pertaining to the position or orientation of a motor vehicle, and may be without limitation a global positioning system (GPS) receiver, an inertial measurement system such as an accelerometer or a gyroscope, a visual measurement system such as a camera, or a geospatial information system (GIS).

Illustrative embodiments enable automobile drivers to more readily operate within their external environments. To that end, some embodiments produce a visual display directly on the windshield of a car highlighting portions of the external environment of interest to the driver. For example, the display may provide the impression of highlighting a portion of the road in front of the automobile, and a turn for the automobile to take. Moreover, the system may coordinate the display orientation with features and movements of the driver. For example, the system may position the displayed highlighted portion of the road based on the location or orientation of the driver's head and eyes. Various embodiments are discussed in greater detail below.

Unlike prior art systems, various embodiments of the invention identify and present the driver with visual data already superimposed on the road in front of him or her. For example, one embodiment models the layout of the road and superimposes the intended travel path right on the windshield. This superimposed path appears to adhere to the contours of the road, instead of copying and displaying traffic directions such as a standard navigation system would produce. The embodiment thus makes complex traffic intersections simple to maneuver, and eliminates the need for the driver to spend seconds, which can be critical at high speeds, to understand exactly what the navigation system is telling him.

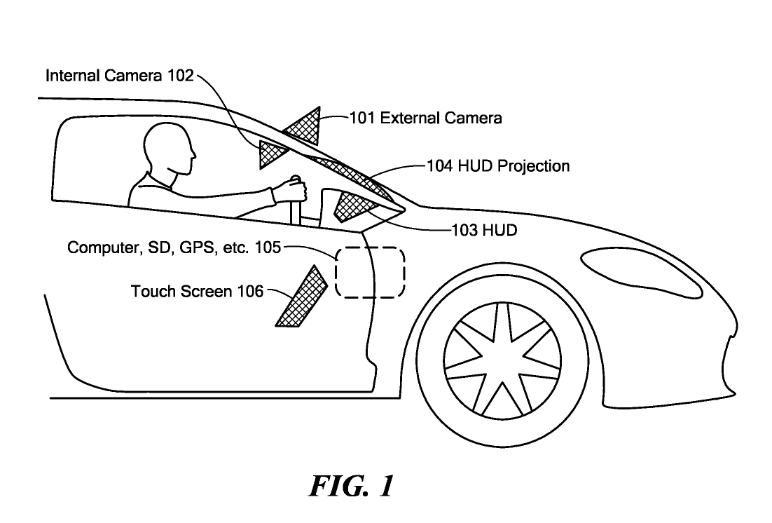

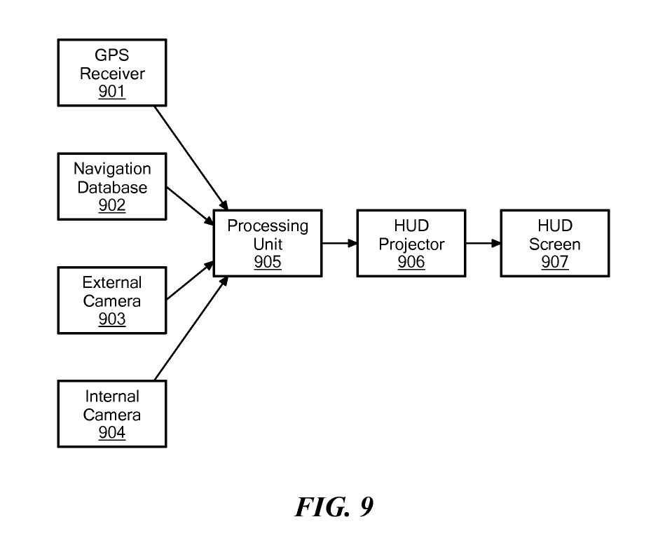

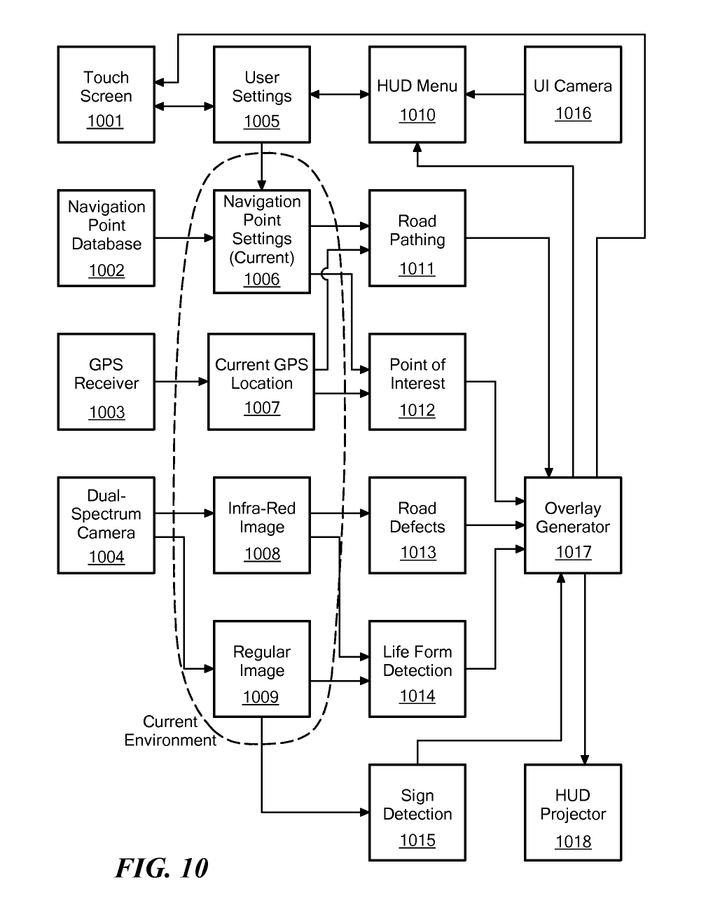

FIG. 1 schematically shows an automobile that may implement illustrative embodiments of the invention. The automobile has an external camera system 101 that images the road in front of and around the vehicle. The external camera system 101 may include, for example, an active infrared camera and a visible spectrum camera. These cameras may produce images that reflect not only the size and shape of the road surface ahead of the motor vehicle, but also the ambient brightness. The vehicle has an internal camera 102 that is oriented so as to capture images of the driver. This internal camera is used to image the driver's face and at least one hand. By analyzing these images, the driver's line of sight and input gestures may be determined. The vehicle also has a heads-up display projector 103 displaying an image 104 on the windshield. Using the line of sight information, image 104 may be controlled to follow the driver's vision. The projector 103 may be any standard projector known in the art. In alternate embodiments, the projector may be replaced by a special windshield having an integrated display screen, or a transparent imaging system that is affixed to the windshield. In these latter embodiments, the image 104 is not a projection, but rather a directly-controlled display image. The vehicle has a processing and data gathering system 105 that includes memory storage, one or more locating sensing devices, and a computing processor for processing image and spatial location and orientation data, as described further below in connection with FIGS. 9 and 10. The vehicle also has an input panel 106. The input panel 106 may be any human-computer interface system, including a touch screen, a voice processing system, and a camera.

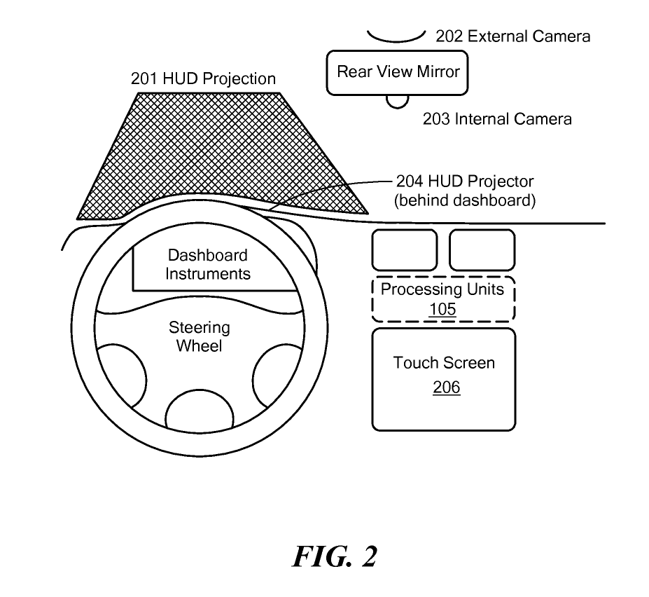

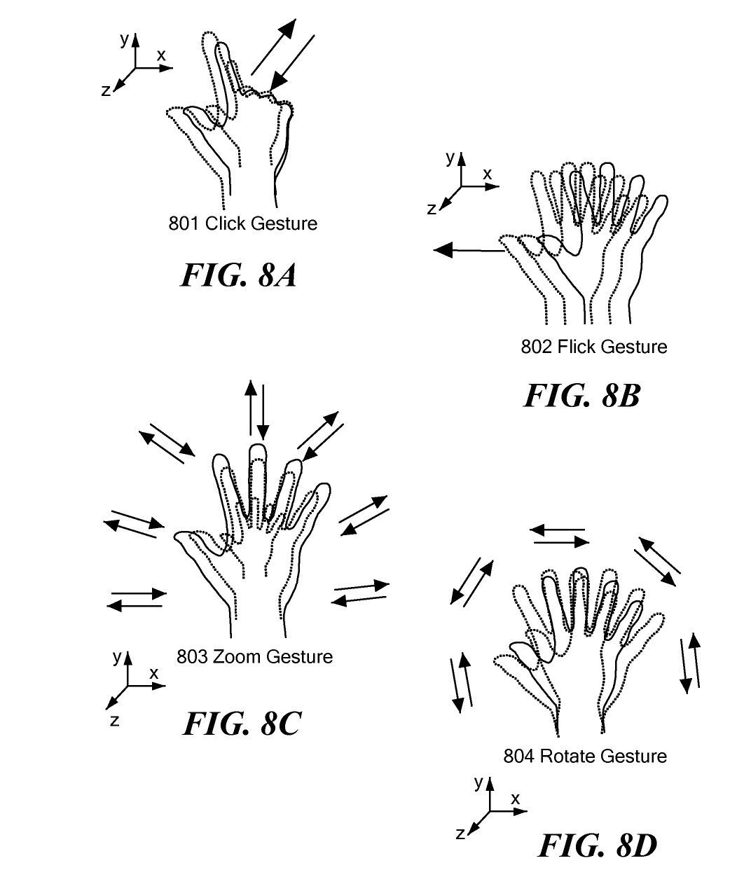

FIG. 2 shows one embodiment of these components from a driver's point of view. In particular, FIG. 2 shows a projected image 201 on the windshield. This image takes the shape of a trapezoid from the driver's perspective, mimicking the shape of a lane in which the vehicle is traveling. An external camera system 202 is mounted on the center front of the outside of the vehicle. An internal camera 203 is mounted on the rear view mirror. This internal camera, which is directed at the driver, may detect both the position and orientation of the driver's eyes and face, and also the position and orientation of one or both of the driver's hands. Using this camera, the HUD system may receive hand gesture input, as described below in connection with FIG. 8. FIG. 2 also shows an indication of the location of the projector 204 hidden behind the dashboard. As noted above, if a different imaging system is used, the projector may not be present. The processing system 105 is shown hidden behind the dashboard as well. Finally, an input panel 206 is shown here as a touch screen. It will be understood that this embodiment is only an example, and various other embodiments may place these components in different places within the vehicle so as to minimize driver distraction or reduce cost.

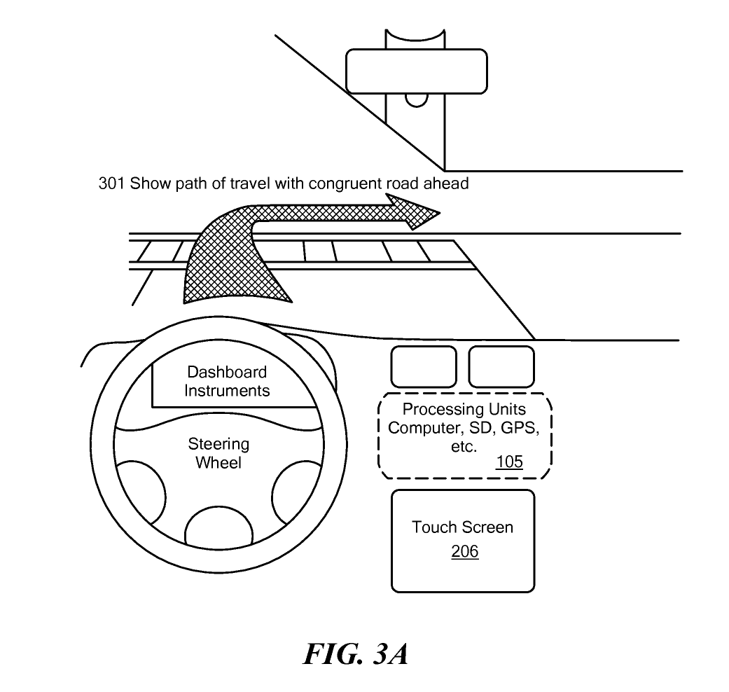

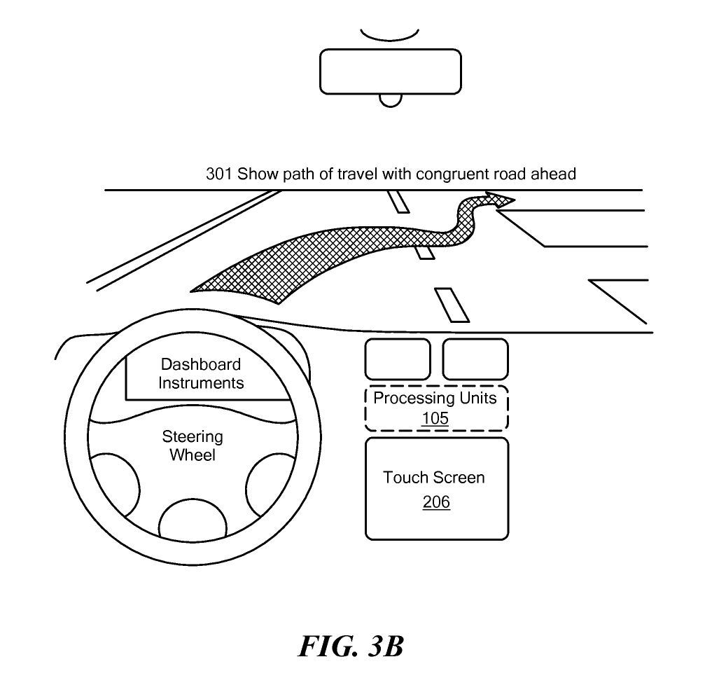

FIGS. 3-7 show various contemplated images displayed on a windshield in a driver's field of view. FIGS. 3A and 3B are representations of the heads-up display showing different navigational information. FIG. 3A shows a path of travel 301 around a corner toward a programmed destination. This path of travel appears to the driver to be overlaid on the roadway using semi-transparent indicia—e.g., an arrow on the road. Similarly, FIG. 3B shows another path of travel 302 that is congruent with the road ahead, this time indicating when one should change lanes.

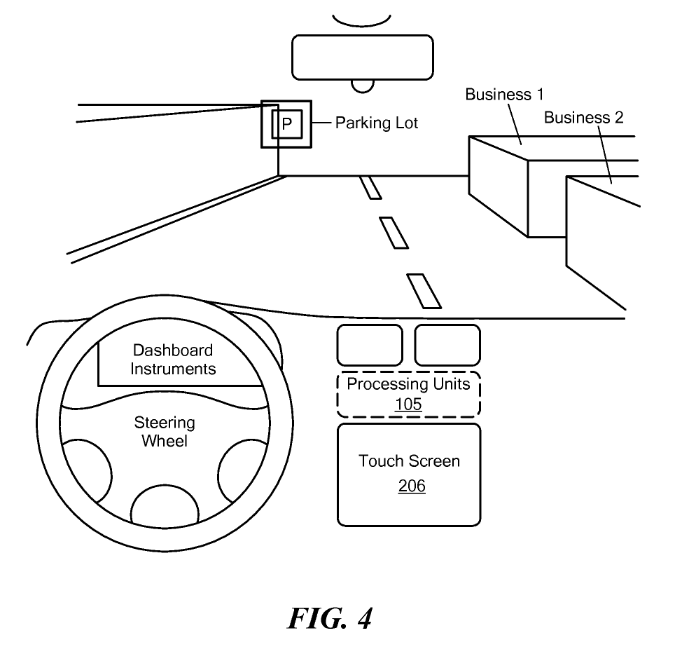

FIG. 4 schematically shows a representation of the heads-up display highlighting identified points of interest in a manner that is aligned with the driver's field of view. Visible outside the motor vehicle are lane markers on a two-lane road, a parking lot building, and two businesses. The system has identified the parking lot by placing an icon surrounding and highlighting a “P” parking sign, and a textual label that indicates a “parking lot”. The system also has identified two businesses as other points of interest, and displayed indications (arrows) having textual labels that identify them by name.

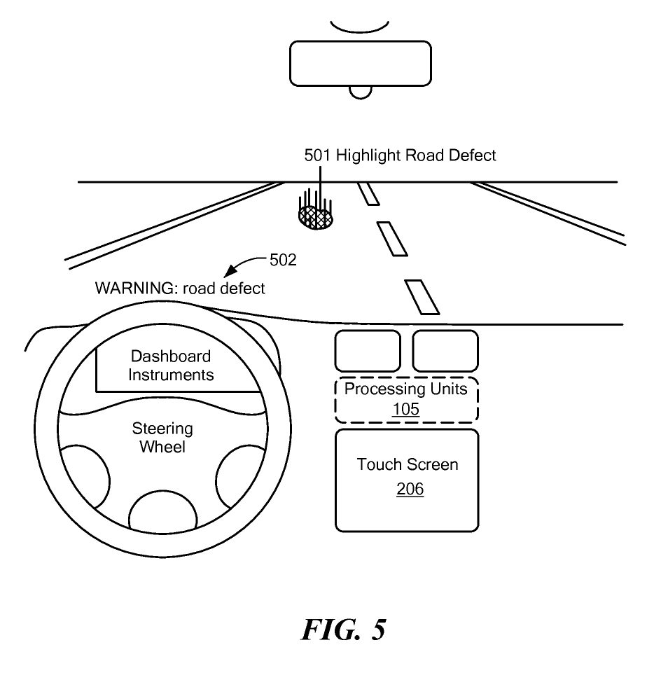

FIG. 5 schematically shows a representation of the heads-up display projector 103 highlighting a recognized defect 501 in a road. The HUD shows a textual warning 502 pertaining to the defect at a fixed position on the windshield. The HUD also shows a column of light that appears to the driver to rise vertically from the road defect, in order to highlight the defect and bring it to the attention of the driver. By altering the projector image, this shape will appear to move to remain superimposed on the defect as the motor vehicle travels down the road. By indicating the defect in two different locations, chances are improved that the driver will be alerted to the danger and steer to avoid the defect.

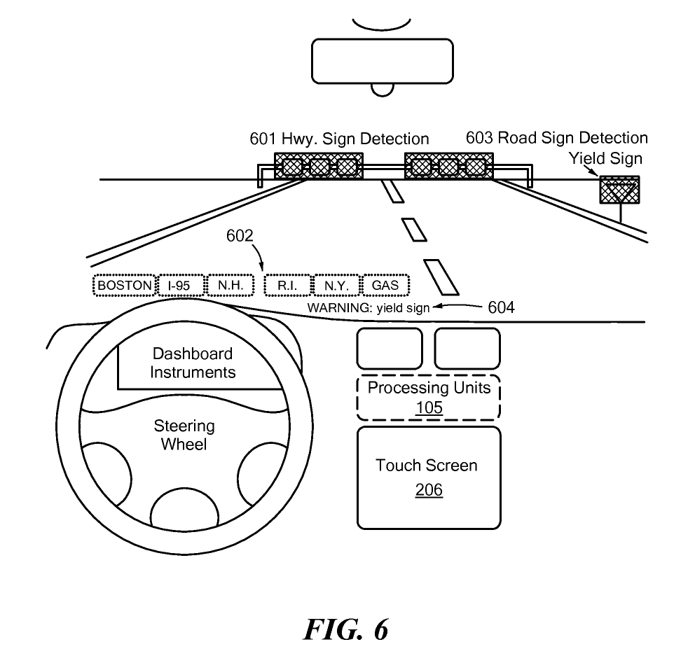

FIG. 6 schematically shows a representation of the heads-up display projector 103 highlighting highway information signs 601. Such signs are typically found above the road surface, as shown, and communicate navigational information pertaining to roads intersecting the road currently being traveled. In accordance with one embodiment, the navigational information communicated by these signs is displayed using icons 602 in a fixed position on the windshield. Thus, for example, the overhead signs of FIG. 6 indicate that turns are available for “Boston”, Interstate Highway “I-95”, New Hampshire “N.H.”, Rhode Island “R.I.”, and New York “N.Y.”, and that “Gas” is available by following one of the turns. In accordance with this embodiment, a road sign 603 is also recognized, in this case a “Yield” sign. A textual warning 604 relating to the detected road sign is shown at a fixed position on the windshield. In addition to simply displaying text relating to these road signs, the HUD may display a shape, such as a shaded box, that surrounds the sign. By altering the projector image, this shape will appear to move to remain superimposed on the sign as the motor vehicle travels down the road.

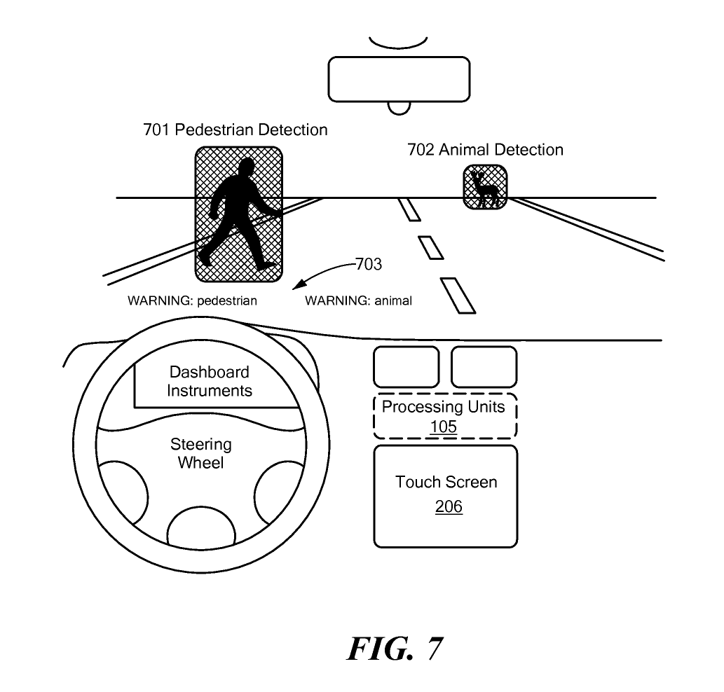

FIG. 7 schematically shows a representation of the heads-up display projector 103 highlighting a recognized person 701 and a recognized animal 702 in the middle of a road. In accordance with this embodiment, once a pedestrian or other life form is detected, or if road debris such as a flat tire is detected, the HUD shows two types of warnings. The life form or debris is highlighted with a moving shape, for example as indicated by the shapes surrounding pedestrian 701 and animal 702, much as road defects are highlighted. At the same time, textual warnings 703 are provided at a fixed position on the windshield, thereby increasing the likelihood that the danger will be avoided.

The user may interact with the system in at least two different ways. First, a touch screen 106, 206 may provide a set of touchable menus that contextually vary based on the vehicle's location and any nearby points of interest or obstacles. Alternatively, the user may provide hand gestures to an internal camera 102, 203 mounted on the interior of the vehicle. When the camera detects motion, it forms a motion energy map by finding the pixels that have changed between the current frame and subsequent frames. The motion energy map is then turned into a motion gradient, which describes the specific motion being made. These motions are used to interact with a menu that appears on the HUD.

More particularly, in one embodiment, four basic hand gestures are used to interact with the HUD menu as shown in FIG. 8. A click gesture 801 may be used to engage the system, and to select any of the items on the menu. This gesture is performed by positioning a hand with an outstretched index finger (representing a virtual pointing device), and moving the entire hand in a forward-and-back motion, as illustrated. The second gesture is a flick of the wrist in a specific direction 802. This motion can be used to push a 3D map shown on the windshield in any direction, and is also used to maneuver through menus shown either on the windshield or on the touch screen. To perform this gesture, the fingers are outstretched as if the driver is pressing down on a virtual map, and the entire hand is moved in a desired scrolling direction. When flicking the wrist, all motions are generalized into the up, down, left, or right directions. Next, moving the hand towards or away from the camera 803, with fingers outstretched, is used to cause the map to zoom in or out. Finally, rotating the hand in any direction 804 causes the map to rotate accordingly.

FIG. 9 shows a block diagram of various important components of one embodiment of the system. Many of these components are discussed above and reiterated here for completeness. Specifically, the components includes, a GPS receiver 901 that provides navigational data and a navigation database 902 that contains GPS position data of navigational nodes, which represent geographic points such as intersections and turns. An external camera system 903 mounted on the front of the vehicle provides enhanced night vision, and can contain both active infrared and visible light-spectrum cameras. One or more internal cameras 904 provide user input data to the processing unit and also scan the driver to determine line of sight and gesture inputs. These four components feed into a processing unit 905, which is typically mounted behind the center console (as noted above). The processing unit illustratively performs all necessary calculations in the system, and provides an image overlay to be projected by an imaging device such as a HUD projector 906. The projector then projects the image on the HUD screen 907. The GPS receiver, navigation database, external camera system, interior camera, and the output for the touch screen are connected to the processing unit using high-speed connections, such as USB or Firewire.

FIG. 10 shows the overall flow of information in the system. As noted above, inputs to the system include a touch screen 1001, a navigation database 1002, a GPS receiver 1003, and an external, dual-spectrum camera system 1004. In one embodiment, the touch screen 1001 controls user settings 1005, although they also may be controlled by driver interaction with a HUD menu 1010 displayed on the windscreen itself. The HUD menu is controlled by images received from a user interface camera 1016, in the passenger compartment, that is oriented to observe driver hand gestures.

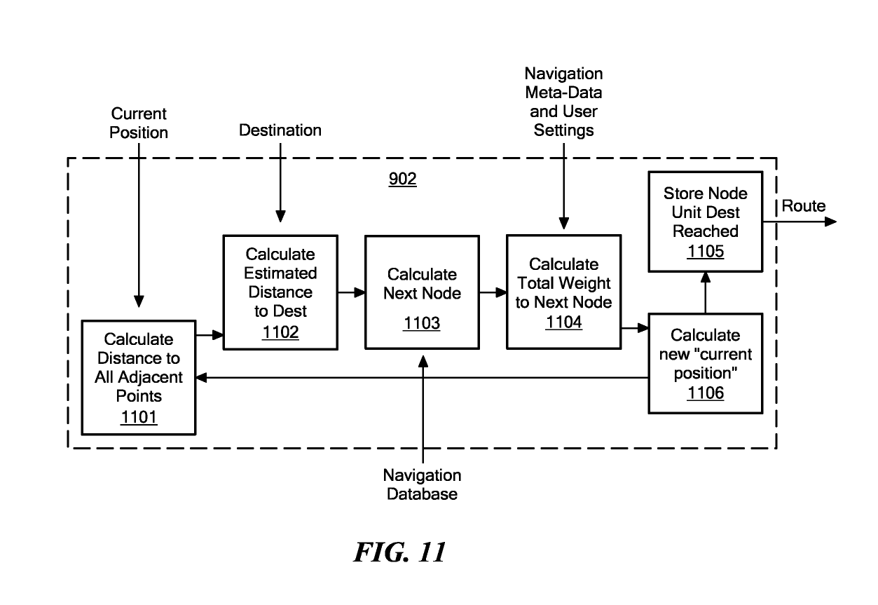

The system models the current situation of the motor vehicle, as indicated by the dashed line. First, the system maintains a collection of waypoints, or navigation point settings 1006 that are based on a route. The route is determined from a user setting (i.e., a destination address or point of interest) and calculated using the points in the navigation point database 1002. More detail regarding route calculation is provided below in connection with FIG. 11. Second, the system maintains data pertaining to the vehicle's current position and orientation 1007, which it receives from one or more location sensing devices such as the GPS receiver 1003. Third, the system maintains an infrared image 1008 and a regular, visible spectrum image 1009 that are received from the externally mounted dual-spectrum camera system 1004.

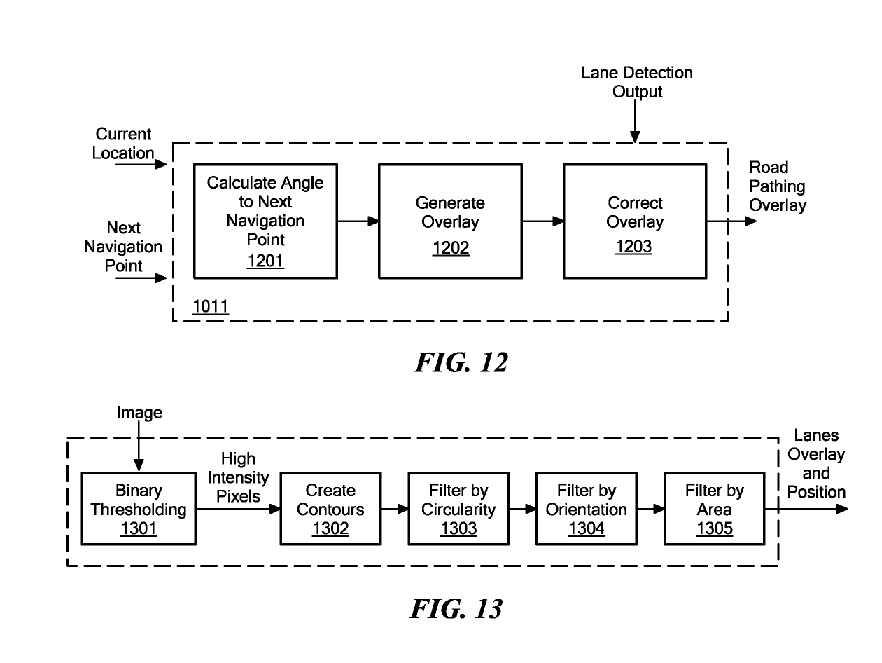

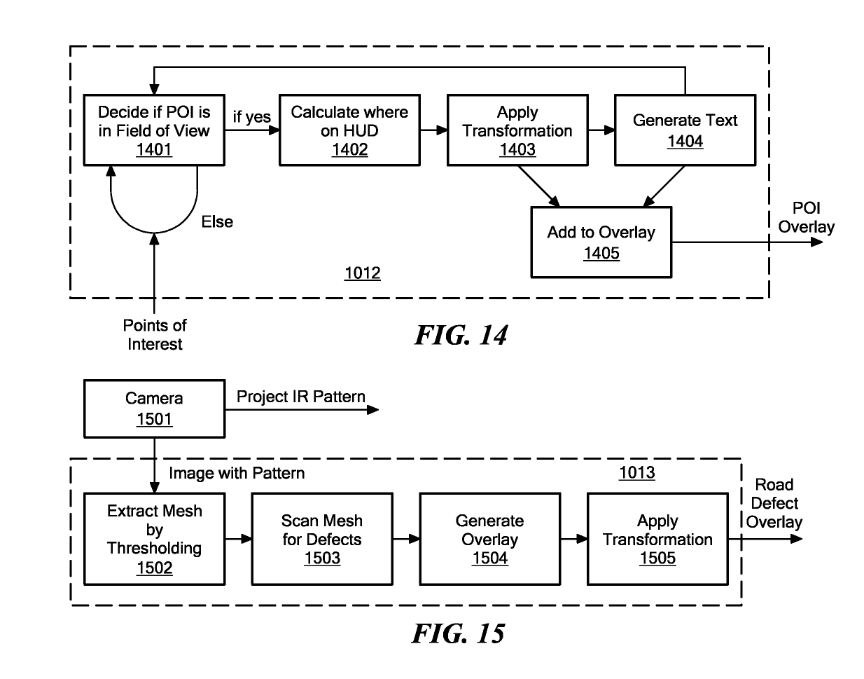

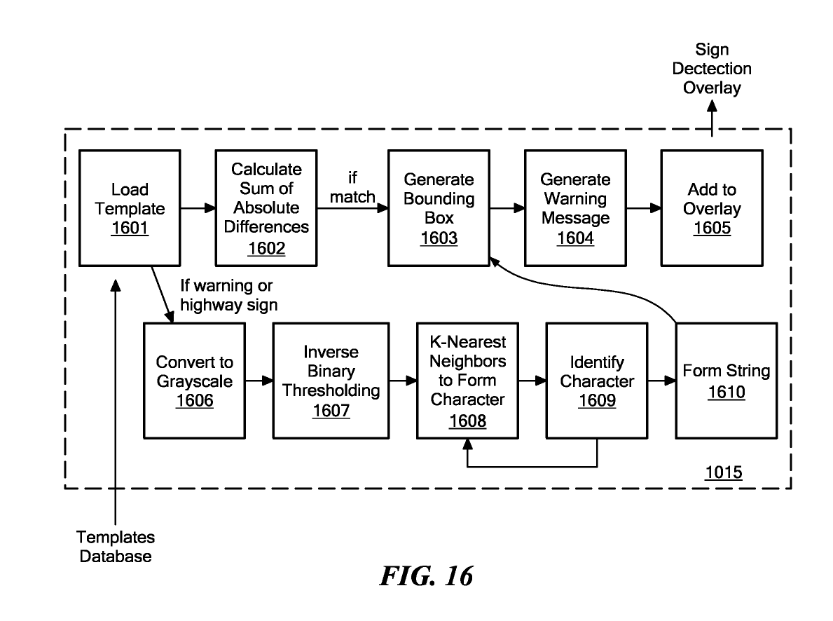

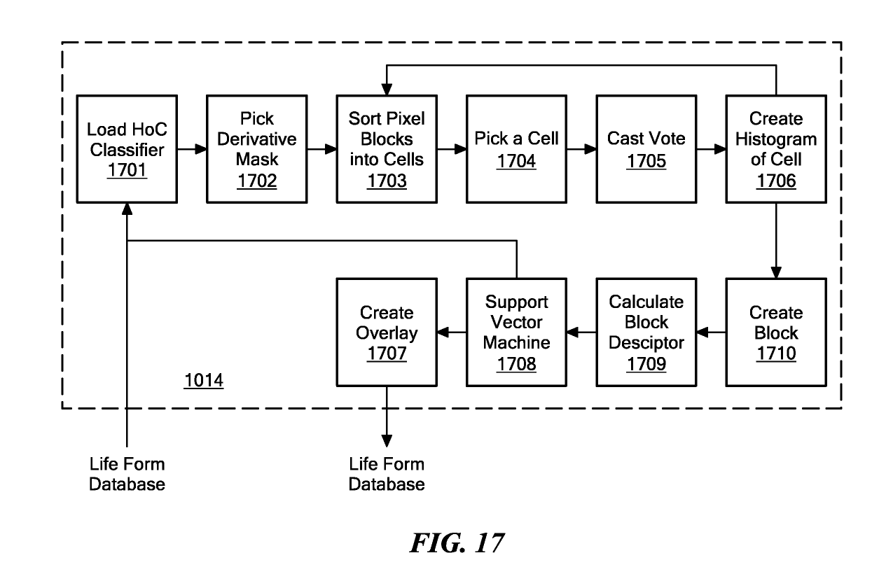

Based on the user settings, any of five functions are enabled. The output of each of these functions is data that will be formed into an image or images and displayed on the windshield. Road pathing 1011 displays navigational information superimposed on the road surface in front of the vehicle as a function of the current navigation point settings and the current vehicle location, and is described in more detail with respect to FIGS. 12 and 13. Notification of points of interest 1012 is a function of these same settings, and is described more fully below in connection with FIG. 14. Notification of road defects 1013 is done with the help of the infrared image, and is described more fully below in connection with FIG. 15. Notification of life forms and road debris 1014 uses both the infrared image and the visible spectrum image, and is described more fully below in connection with FIG. 17. Notification of overhead and roadside signage 1015 uses only the visible spectrum image, and is described more fully below in connection with FIG. 16.

These five functions each produce output data that feeds into an overlay generator 1017 that generates the appropriate overlay. The output of the overlay generator includes an image that may be displayed on the touch screen 1001, a menu image that is displayed as HUD menu 1010, or a navigational and warning image. All overlays are combined using a priority-based queue: the detection algorithms 1012-1015 are performed first, so that their inputs are not obscured by the output of the road pathing algorithm 1011. Once the final image for the HUD has been generated, the image is transformed according to the shape of the windshield, and is sent to one or more HUD projectors 1018 to be displayed on the windshield.

The various sub-systems are now described in more detail. FIG. 11 shows the method used to calculate the desired navigation path. Upon start-up, the driver is able to select a destination either by entering the address, in which case the system finds the GPS coordinates by searching through the database, or by selecting from a number of either pre-programmed and custom points-of interest (POIs) found in a storage unit. Once a destination is selected, the system calculates the route from the current position to the destination using a shortest-path algorithm, such as the A* algorithm. For this graphing algorithm, intersections are represented by nodes, and the distance between intersections is the relative weight of each connection.

The A* algorithm begins at the “current” position of the vehicle (initially the GPS position of the vehicle), and calculates the distance from that position to all adjacent nodes (road intersections) in process 1101. It then uses geographic distance from the node to the destination, calculated in process 1102, as an estimation heuristic to calculate the next node in the sequence in process 1103. For each node, the estimation heuristic and the distance are added together to get the total weight for each node in process 1104. The node with the lowest total weight becomes the new “current” position in process 1106, and the process is repeated for all nodes adjacent to the current position. As the algorithm travels from node to node, the sequence of waypoints is stored in process 1105. The algorithm terminates when the destination node becomes the current position. The shortest path is then the stored sequence of waypoints leading from the first node to the destination node.

In some embodiments, the weight of each connection is augmented by traffic data obtained from live data feeds, such as RSS or XML feeds, using a mobile Internet connection protocol such as IMT-2000 (3G). Also, the user is able to set certain route requirements, such as not travelling on toll roads, via the route settings menu on the user interface 1005. Once the route is calculated, the set of navigation points that represents the route is loaded into the system as navigation point settings 1006. A navigation point is the specific GPS coordinate of a deviation in the path of the route; that is, a turn in the road or at an intersection. This set of coordinates, in conjunction with the current position of the car, may be used to generate a 3D directional map that appears in one corner of the HUD.

To display navigational data on the HUD display, the system uses a road pathing technique 1011. FIG. 12 shows the process used to produce the road pathing overlay. This algorithm has four inputs. The first input is the current location and orientation 1007 of the vehicle, as stored in the system model of the current environment. The second input is the curvature of the road surface, as determined from an image 1009 received from the front-facing external camera system. The third input is the next navigational point stored in the navigation point settings 1006. The fourth input is the viewing direction of the driver, as determined from an image received from the internal user interface camera 1016.

In process 1201, the algorithm calculates the angle between the current orientation of the vehicle and the next navigational point. In process 1202, it generates an initial overlay of a transparent directional arrow pointing at that angle from the front of the car. As might be easily imagined, the next waypoint is often not directly in front of the motor vehicle. Therefore, in process 1203, this preliminary arrow is corrected by a lane detection algorithm (such as the one shown in FIG. 13) that is performed on the regular-spectrum image. If the next navigational waypoint (other than the destination) lays approximately within the visible extent of the arrow on the windshield, then a turn is approaching. In this case, the angle between the current waypoint and the next is calculated, and the arrow is modified to denote the turn. The final overlay is that of a semi-transparent arrow directing the vehicle to the next point. Using the lane detection algorithm, the system may also show correct lane changes across multiple lanes that are congruent to the road. Thus, for example, if a turn is approaching and the vehicle is in a distant lane, the angle between the current orientation of the vehicle and the next waypoint may begin to change rapidly compared to the distance to the turn. In this case, a lane change is indicated.

Lane detection algorithms are used to detect the explicit extent of the lane in the roadway. FIG. 13 demonstrates one such algorithm used to detect lanes in an image. The algorithm takes the regular light-spectrum image 1009 from the dual camera system as an input. In process 1301, the image is subjected to a binary intensity threshold; that is, only pixels having an intensity above a given high value are further processed. These pixels are typically the white, reflective pixels of the lane divider markings, in addition to other high-intensity pixels that must now be filtered out. In process 1302, the system creates a contoured image from all remaining pixels to form shape outlines. In process 1303, these outlines are filtered by circularity. As lane markings are polygonal in nature, any circular contours are discarded. In process 1304, the remaining outlines are filtered by orientation, so that polygons not approximately aligned with the orientation of the vehicle are discarded. Finally, in process 1305 the remaining contours are filtered by area, so that only the contours in an appropriate area of the image are retained. The remaining contours are marked as lane lines, and the direction of the road is thereby established.

FIG. 14 shows the flow of the point-of-interest algorithm 1012. Points of interest (“POIs”) are stored as navigation points 1006 in the system model of the current environment. In process 1401, the computer processor iterates through each POI and determines whether the angle from the current orientation of the vehicle to the POI would place it in the area of the windshield covered by the HUD. If so, the position of the POI on the HUD is calculated using its GPS coordinates and the current position and orientation of the vehicle 1007. Next, in process 1403 a representative image is retrieved from memory and a transformation is applied to the image as a function of the driver line of sight so that, when the image is projected, it will appear to the driver as if it surrounds or highlights the POI. In process 1404, text representative of the POI may be generated or retrieved from memory. The transformed image and text are then added to the overlay in process 1405.

The process used to detect road defects 1013 is illustrated in FIG. 15. First, an infrared pattern is projected onto the road surface in front of the motor vehicle. The light has a transmission pattern, or grid. The reflected light is imaged by an infrared camera 1501. In process 1502, the system recovers a reflection mesh pattern by intensity thresholding, in a manner similar to process 1301. If the road surface is perfectly smooth, then the reflected light will retain the transmission pattern, but if the road surface has any defects (such as a pothole), the shape of the defect will cause the reflection pattern to be deformed. Thus, in process 1503, the computing processor scans the reflection mesh pattern for defects, which it locates by determining a difference between the known transmission pattern from the infrared light source and the reflection pattern on the infrared image. If any such imperfections are found, the system calculates whether they are caused by a road defect large enough to cause damage to the vehicle. If such a large defect is found, in process 1504 the pixel positions are marked in the overlay. In process 1505, the overlay is transformed to account for driver point of view, in a manner similar to process 1403, so that it appears to be superimposed on the actual defect from the driver's point of view. In addition to simply marking the pixel positions in the overlay, a column of virtual light or other highlighting effect such as a blinking box around the defect may be added, so that the driver's attention is quickly drawn to the defect. Also, the system may display warning text at fixed position on the HUD, or produce a warning sound, including recorded speech.

The template matching and optical character recognition algorithms 1015 used to detect and read signs are shown in FIG. 16. The sign detection algorithm detects signs and displays their content at the bottom of the HUD using a form of image template matching. First, in process 1601 templates are loaded, each template representing a different kind of sign. Next, in process 1602 the algorithm runs a sign recognition algorithm across the regular-spectrum image 1009.

In one embodiment, the “sum of absolute differences algorithm” is used for sign recognition as template matching algorithm 1602. This algorithm takes an image of a given sign as a template and centers it around a first pixel in the image. Then, for each pixel that falls underneath the template, the absolute difference between that pixel value and the template pixel value is calculated. These values are summed up, and the value assigned to the center pixel. Then, the template is shifted to a new center pixel. Once all the pixels in the image have a value assigned, the pixel having the lowest “sum of absolute differences” value is the center position of the best match for the template. Any positions whose value exceeds a certain threshold are marked as signs.

Signs found by the recognition algorithm are sorted into four categories based on shape and position. Stop signs are octagonal, yield signs are triangular, warning signs are rectangular and to the side of the road, and highway signs are rectangular and above the road. If the sign is a warning sign or a highway sign, its meaning cannot be determined solely from its shape, so the algorithm proceeds to process 1606 and a multi-step optical character recognition (OCR) algorithm is run over the sign to determine its meaning This sub-algorithm first converts the image of the sign to grayscale in process 1606. Next, it performs an inverse binary thresholding process 1607 to create an image with the subject letters (typically black) at full intensity and the background (typically white) at zero intensity. The sub-algorithm finds a bounding box for the first letter; that is, a smallest rectangle of zero intensity pixels that surrounds at least one pixel in the first letter.

Next, in process 1608 the pixels in this bounding box are fed into a K-Nearest Neighbors classifier. According to this classifier, each pixel is classified as being either part of the letter or not part of the letter depending on the classifications of its K nearest neighbor pixels (for some value of K). The value of K and the classifications may be pre-trained, for example using a neural network that has been manually trained using several thousand diverse images. In process 1609, the identified pixels are compared to a list of characters. When the correct character is found, it is added to a text string in process 1610. Then the area under the bounding box is blanked, and the processes 1608 through 1610 are repeated with the next letter.

When no high-intensity pixels remain in the image, the sub-algorithm terminates, and the letters in the string are the contents of the sign. This string is formed into a warning message in a process 1604. The position of any detected sign in the HUD is calculated from the original image using an appropriate linear transformation, and an overlay is generated in process 1605 that draws a box around the sign based on the line of sight of the driver, and displays its contents as the warning message at the bottom of the HUD. By displaying both a visible bounding box around the sign and warning text, the driver may be quickly alerted to any navigational warnings or other information.

FIG. 17 shows the process used to detect obstacles in the path of the vehicle. At system start, a pre-trained HoG classifier is loaded (1701). As each frame comes in, it is filtered by a derivative mask (1703), like a Gaussian filter, and each chunk of pixels is sorted into cells (1703). Each pixel in a cell casts a vote with a weight pertaining to the value of the calculated derivative (1705), and a histogram is made of those votes (1706). Cells are grouped into blocks of arbitrary size (1710), and the descriptor for each block is calculated (1709). These descriptors are run through a pre-trained support vector machine (1708), and the return from the SVM indicates whether a block is part of the pixel location of an obstacle. Bounding blocks are generated for the positive blocks and an overlay is created from these boxes (1707).

Obstacles, such as life forms, in the path of the vehicle are detected by scanning an infrared image using a trained classifier. For example, the process of FIG. 17 uses a histogram of oriented gradients (HOG) classifier, which will detect people and certain other life forms, such as deer, moose, and other animals. The HOG algorithm works on gradients (large changes) of color or intensity from one pixel to the next in an image. These gradients generally correspond to corners or edges of objects. The gradients are oriented (given a direction), and pixels having the same orientation are counted to form a histogram that represents a “fingerprint” of the bodily symmetry of an object, such as a life form. This fingerprint may be trained in a neural network by subjecting the network to thousands of images along with descriptors of the objects being imaged. If such an object appears in an image captured by the external camera system, the HOG algorithm will detect its “fingerprint” and action may be taken to alert the driver.

A particular implementation is now described. In process 1701, the HOG classifier is loaded into the computing processor. In process 1702, a derivative mask is run over the entire image. This mask is a function that computes the derivative, or difference, between each pair of adjacent pixel values to compute pixel gradient values. In process 1703, the pixels are sorted into cells, which are rectangular blocks of pixels. In process 1704, a cell is selected, and in process 1705 each pixel in the cell casts a weighted “vote” for the cell to belong to one of an arbitrary number of orientations. The pixel “votes” for its own orientation (or one nearby), and its “vote” is weighted by the magnitude of its gradient. The result of the voting process are tabulated in process 1706 to form a histogram for the cell. If no result is found, the pixel blocks may be resorted into new cells, as indicated.

If a result is found, then in process 1710 the cells are grouped into blocks. In process 1709, a block descriptor (i.e., a “fingerprint”) is calculated by normalizing the cell histograms. In process 1708, these normalized cell histograms are then fed into a binary classifier, such as a support vector machine (SVM) known in the art. If this classifier determines that certain blocks represent life forms in the infrared image 1008, the relative position of the life form on the HUD is calculated from the original infrared image, and an overlay created that marks this position as a life form, in a manner similar to process 1405.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method of reducing the distraction of a driver of a motor vehicle, the motor vehicle having a windshield in front of the driver, the method comprising:
receiving an image from a generally front facing camera system mounted on the motor vehicle, the image including data regarding a portion of a road surface generally in front of the motor vehicle and an ambient brightness;
receiving data pertaining to the position and orientation of the motor vehicle from at least one location sensing device;
computing a desired route between the position of the motor vehicle and a destination; and
displaying, on the windshield, a navigational image that is computed as a function of the desired route, the position and orientation of the motor vehicle, a curvature of the portion of the road surface, and a line of sight of the driver, the navigational image appearing, to the driver, to be superimposed on the road surface in front of the motor vehicle.

2. A method according to claim 1, wherein the navigational image has a brightness and a transparency that are calculated as a function of the ambient brightness.

3. A method according to claim 1, wherein receiving an image includes receiving an active infrared image or receiving a visible light spectrum image.

4. A method according to claim 1, wherein the line of sight of the driver is determined by analyzing an image of the driver's face.

5. A method according to claim 1, wherein the motor vehicle is positioned on a road having an intersection, and the navigational image indicates that the driver should turn the motor vehicle at the intersection.

6. A method according to claim 1, further comprising displaying on the windshield a shape that appears, to the driver, to surround an object outside the motor vehicle, the object being one of: a point of interest, a road defect, an elevated highway sign, a roadside traffic sign, a pedestrian, animal, or other road debris.

7. A method according to claim 6, wherein the displayed shape further comprises an iconic label that identifies the object.

8. A method according to claim 6, further comprising displaying, in a fixed position on the windshield, a textual image that conveys information relating to the highlighted object.

9. A method according to claim 6, wherein when the object is a road defect, the shape includes a column of light that appears to the driver to rise vertically from the road defect.

10. A method according to claim 6, wherein when the object is a pedestrian, animal, or road debris, the shape includes a shaded box that surrounds the detected object.

11. A method according to claim 6, wherein when the object is an elevated highway sign or a roadside traffic sign, the shape includes a shaded box that surrounds the sign.

12. A method according to claim 11, further comprising displaying the text of the sign in a fixed position on the windshield.

13. A method according to claim 1, further comprising:
projecting a light on the road surface in front of the motor vehicle, the light having a transmission pattern;
imaging a reflection from the road of the shined light, the reflection having a reflection pattern;
in a computing processor, determining a difference between the transmission pattern and the reflection pattern, the difference being indicative of a defect in the road surface; and
displaying, on the windshield, an image representing the defect, the displayed image being based on a line of sight of the driver so that the image appears, to the driver, to be superimposed on the road surface in front of the motor vehicle.

14. A method according to claim 13, wherein shining the light comprises shining light having infrared frequencies.

15. A method according to claim 1, further comprising:
using a histogram of orientated gradients to identify, in the received image, an object having a bodily symmetry of a life form; and
displaying, on the windshield, an image representative of the identified life form.

16. A method according to claim 1, further comprising:
determining that the received image includes a depiction of a road sign;
analyzing the image to determine a shape of the road sign;
if a meaning of the road sign cannot be determined from its detected shape, analyzing the image to determine any text present on a face of the road sign; and
displaying, on the windshield, an image relating to the road sign based on the line of sight of the driver.

17. A method according to claim 16, further comprising displaying, on a fixed position of the windshield, an image comprising the text of the sign.

18. A system for reducing the distraction of a driver of a motor vehicle, the motor vehicle having a windshield in front of the driver, the windshield having a given three-dimensional shape, the system comprising:
an imaging system configured to produce images on the windshield;
a first camera for imaging the interior of the motor vehicle, the first camera being oriented to capture images of the driver;
a second camera for imaging a road in front of the motor vehicle;
a touch screen for configuring the system;
a location sensing device for obtaining data that indicate the current position and orientation of the motor vehicle; and
a computing processor coupled to the imaging system, first camera, second camera, touch screen, and location sensing device, the computing processor being configured to:
(i) determine a line of sight of the driver based on images received from the first camera;
(ii) create navigational images based on data received from the second camera, the location sensing device, data received from the touch screen, and the line of sight;
(iii) transform the navigational images according to the given three-dimensional shape of the windshield, and
(iv) cause the imaging system to display the transformed images on the windshield so that the images appear, to the driver, to be superimposed on the road surface in front of the motor vehicle.

19. A system according to claim 18, wherein the second camera is configured to detect an ambient brightness, and the navigational image has a brightness and a transparency that are calculated as a function of the ambient brightness.

20. A system according to claim 18, wherein the at least one location sensing device is one of: a global positioning system receiver, an inertial gyroscope, an accelerometer, or a camera.

21. A system according to claim 18, wherein the processor determines the line of sight by analyzing an image of the driver's face.

22. A system according to claim 18, wherein the imaging system is further configured to display a shape that appears, to the driver, to surround an object outside the motor vehicle, the object being one of: a point of interest, a road defect, an elevated highway sign, a roadside traffic sign, a pedestrian, animal, or other road debris.

23. A system according to claim 22, wherein the displayed shape further comprises a textual label or an iconic label that identifies the object.

24. A system according to claim 22, wherein the imaging system is further configured to display, in a fixed position on the windshield, a textual image that conveys information relating to the highlighted object.

25. A system according to claim 22, wherein when the object is a road defect, the shape includes a column of light that appears to the driver to rise vertically from the road defect.

26. A system according to claim 22, wherein when the object is a pedestrian, animal, or road debris, the shape includes a shaded box that surrounds the detected object.

27. A system according to claim 22, wherein when the object is an elevated highway sign or a roadside traffic sign, the shape includes a shaded box that surrounds the sign.

28. A system according to claim 27, wherein the imaging system is further configured to display the text of the sign in a fixed position on the windshield.

29. A system according to claim 18, further comprising:
a light having a transmission pattern aimed at the road surface in front of the motor vehicle;
wherein the second camera is configured to image a reflection from the road of the light, the reflection having a reflection pattern; and
the computer processor is further configured to
determine a difference between the transmission pattern and the reflection pattern, the difference being indicative of a defect in the road surface, and
cause the imaging system to display, on the windshield, an image representing the defect, the displayed image being based on a line of sight of the driver so that the image appears, to the driver, to be superimposed on the road surface in front of the motor vehicle.

30. A system according to claim 29, wherein the light is an infrared light.

31. A system according to claim 18, wherein the computer processor is further configured to use a histogram of orientated gradients to identify, in the received image, an object having a bodily symmetry of a life form, and to cause the imaging system to display, on the windshield, an image representative of the identified life form.

32. A system according to claim 18, wherein the computer processor is further configured to:
determine that the received image includes a depiction of a road sign;
analyze the image to determine a shape of the road sign;
if a meaning of the road sign cannot be determined from its detected shape, analyze the image to determine any text present on a face of the road sign; and
cause the imaging system to display, on the windshield, an image relating to the road sign based on the line of sight of the driver.

33. A system according to claim 32, wherein the imaging system displays, on a fixed position of the windshield, an image comprising the text of the sign.

34. A system according to claim 18, wherein the first camera is configured to capture video of one of the driver's hands, the video comprising a succession of images, each image consisting of a plurality of pixels, and the computer processor is further configured to detect the motion of the one of the driver's hands by calculating a motion gradient based on differences between the pixels of successive images of the video, and to issue commands to configure the system based on the direction of the detected motion gradient of the one of the driver's hands relative to a coordinate system.

35. A method according to claim 34, wherein the system includes a menu function, a zoom function, and a rotate function, and wherein the direction of the detected motion gradient and a current state of the system together indicate whether to issue, to the system, a selection command, a menu navigation command, a zoom command, or a rotate command.
